(19) United States
(12) Patent Application Publication
(10) Pub. No.: US 2025/0276589 A1
(43) Pub. Date: Sep. 4, 2025

(54) VEHICLE, VEHICLE CONTROL DEVICE, AND VEHICLE CONTROL METHOD

(71) Applicants: TOYOTA JIDOSHA KABUSHIKI KAISHA, Toyota-shi, Aichi-ken (JP); DENSO CORPORATION, Kariya-shi, Aichi (JP)

(72) Inventors: Toshiya HASHIMOTO, Miyoshi-shi (JP); Kazutaka KIMURA, Mishima-shi (JP); Makoto HASHIMOTO, Seto-shi (JP); Keisuke TANI, Kariya-shi (JP); Nobuhisa YAMAGUCHI, Kariya-shi (JP); Kazuyoshi OBAYASHI, Kariya-shi (JP); Masaki KANESAKI, Kariya-shi (JP); Yuichi TAKEMURA, Kariya-shi (JP)

(73) Assignees: TOYOTA JIDOSHA KABUSHIKI KAISHA, Toyota-shi, Aichi-ken (JP); DENSO CORPORATION, Kariya-shi, Aichi (JP)

(21) Appl. No.: 18/862,412

(22) PCT Filed: Apr. 5, 2023
(86) PCT No.: PCT/JP2023/014129

§ 371 Date: Nov. 1, 2024

(30) Foreign Application Priority Data
May 23, 2022 (JP) 2022-083888

(51) Int. Cl. B60L 53/122; B60L 1/00; B60L 53/20; B60L 53/30; H02J 50/12

(52) U.S. Cl. CPC B60L 53/122; B60L 1/003; B60L 53/20; B60L 53/32; H02J 50/12; B60L 2210/10; B60L 2240/12; B60L 2240/545; B60L 2240/662

(57) ABSTRACT

A vehicle includes: a battery; an electric load; a power receiver having a power receiving coil that receives power from a power transmission coil installed on a road; a DC/DC converter that uses a switching element to convert the voltage value of DC power output from the power receiver; and a control device that controls the DC/DC converter. On the basis of predetermined conditions, the control device switches the states of the DC/DC converter when power is supplied from the power receiver to the battery and/or the electric load via the DC/DC converter between a non-operating state in which the switching element is maintained in the on state and an operating state in which the switching element is switched between the on and off states.

### FIELD

The present invention relates to a vehicle, a vehicle control device, and a vehicle control method.

### BACKGROUND

Conventionally, a technology for transmitting electric power in a contactless manner by using a transmission system such as a magnetic field resonance system is known (for example, JP 2013-191913 A). In such a technology, alternating-current power generated in a power-receiving coil by contactless power feeding is converted into direct-current power, and the voltage value of the direct-current power is converted by a DC-DC converter.

When such as technology is applied to contactless power feeding of a vehicle, electric power received by a power-receiving coil provided in the vehicle is supplied to a battery or the like through a DC-DC converter. At this time, an electric energy can be adjusted by the DC-DC converter, and stable power supply to the vehicle can be achieved.

### SUMMARY

### Technical Problem

However, when voltage conversion by a switching operation is performed every time electric power is supplied through the DC-DC converter, a power loss due to the switching operation occurs in the vehicle.

Then, in view of the aforementioned issue, an object of the present invention is to suppress a power loss in a vehicle while securing required electric power by power feeding when contactless power feeding to the vehicle is performed.

### Solution to Problem

A summary of the present disclosure is as follows.

(1) A vehicle including: a battery; an electric load; a power reception device including a power-receiving coil receiving electric power from a power-transmitting coil provided on a road; a DC-DC converter converting, by using a switching element, a voltage value of direct-current power output from the power reception device; and a control device controlling the DC-DC converter, wherein, based on a predetermined condition, the control device switches a state of the DC-DC converter when electric power is supplied from the power reception device to at least one of the battery and the electric load through the DC-DC converter between a non-operating state in which the switching element is maintained in an on-state and an operating state in which the switching element is switched between an on-state and an off-state.

(2) The vehicle according to the aforementioned item (1), wherein the control device sets a state of the DC-DC converter to the non-operating state when a predetermined received power reduction condition is satisfied.

(3) The vehicle according to the aforementioned item (2), wherein the received power reduction condition is that a length of a power feeding area in which the vehicle travels has a value equal to or greater than a predetermined value.

(4) The vehicle according to the aforementioned item (2), wherein the received power reduction condition is that an SOC of the battery has a value equal to or greater than a predetermined value.

(5) The vehicle according to the aforementioned item (2), wherein the received power reduction condition is a condition related to an electric energy consumed in the vehicle.

(6) The vehicle according to the aforementioned item (5), wherein the electric load includes a motor, and the received power reduction condition includes that power consumption of the motor has a value equal to or less than a predetermined value.

(7) The vehicle according to the aforementioned item (5) or (6), wherein the received power reduction condition includes that speed of the vehicle has a value equal to or less than a predetermined value.

(8) The vehicle according to any one of the aforementioned items (5) to (7), wherein the electric load includes an air conditioner, and the received power reduction condition includes that power consumption of the air conditioner has a value equal to or less than a predetermined value.

(9) The vehicle according to any one of the aforementioned items (5) to (8), wherein the electric load includes an air conditioner, and the received power reduction condition includes that outdoor temperature is within a predetermined range.

(10) The vehicle according to any one of the aforementioned items (1) to (9), wherein the control device sets a state of the DC-DC converter to the operating state when a predetermined power fluctuation inhibition condition is satisfied while electric power is supplied from the power reception device to the battery through the DC-DC converter.

(11) The vehicle according to the aforementioned item (10), wherein the power fluctuation inhibition condition includes that temperature of the battery is out of a predetermined range.

(12) The vehicle according to the aforementioned item (10) or (11), wherein the power fluctuation inhibition condition includes that each of electric power that can be charged to the battery and electric power that can be discharged from the battery has a value equal to or less than a predetermined value.

(13) A vehicle control device that controls a vehicle including: a battery; an electric load; a power reception device including a power-receiving coil receiving electric power from a power-transmitting coil provided on a road; and a DC-DC converter converting, by using a switching element, a voltage value of direct-current power output from the power reception device, wherein, based on a predetermined condition, a state of the DC-DC converter when electric power is supplied from the power reception device to at least one of the battery and the electric load through the DC-DC converter is switched between a non-operating state in which the switching element is maintained in an on-state and an operating state in which the switching element is switched between an on-state and an off-state.

(14) A vehicle control method for controlling a vehicle including: a battery; an electric load; a power reception device including a power-receiving coil receiving electric power from a power-transmitting coil provided on a road; and a DC-DC converter converting, by using a switching element, a voltage value of direct-current power output from the power reception device, the method including, based on a predetermined condition, switching a state of the DC-DC converter when electric power is supplied from the power reception device to at least one of the battery and the electric load through the DC-DC converter between a non-operating state in which the switching element is maintained in an on-state and an operating state in which the switching element is switched between an on-state and an off-state.

### Advantageous Effects of Invention

The present invention can suppress a power loss in a vehicle while securing required electric power by power feeding when contactless power feeding to the vehicle is performed.

### BRIEF DESCRIPTION OF DRAWINGS

FIG. 1 is a diagram schematically illustrating a configuration of a contactless power feeding system.

FIG. 2 is a diagram schematically illustrating a supply path of electric power in a vehicle.

FIG. 3 is a diagram illustrating an example of a configuration of a DC-DC converter.

FIG. 4 is a schematic configuration diagram of an ECU in a vehicle and equipment connected to the ECU.

FIG. 5 is a diagram illustrating an example of a power feeding area where a power-transmitting coil in a power feeding device is installed.

FIG. 6 is a flowchart illustrating a control routine of power reception processing.

### DESCRIPTION OF EMBODIMENTS

An embodiment of the present invention will be described in detail below with reference to drawings. Similar components are given the same reference sign in the following description.

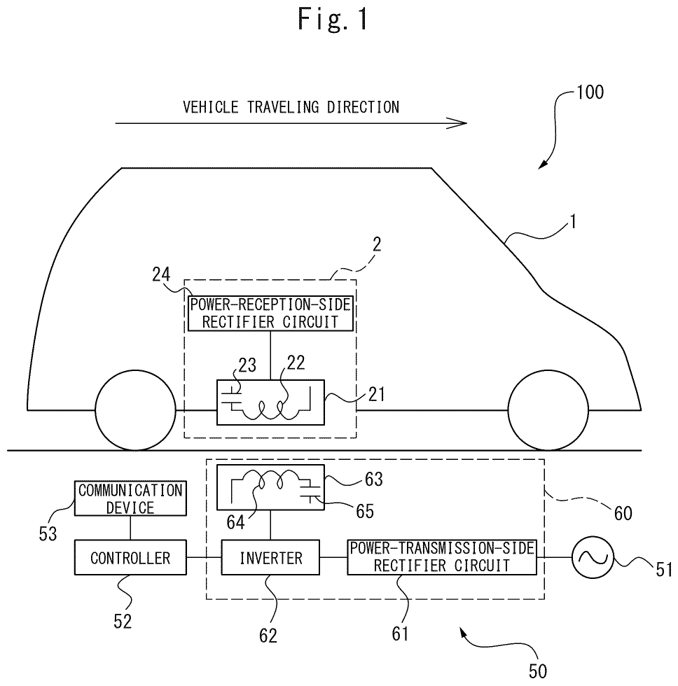

First, a configuration for supplying electric power to a vehicle in a contactless manner by using a power feeding device will be described. FIG. 1 is a diagram schematically illustrating a configuration of a contactless power feeding system 100. The contactless power feeding system 100 includes a power feeding device 50 and a vehicle 1 and performs contactless power feeding between the power feeding device 50 and the vehicle 1. In particular, the contactless power feeding system 100 according to the present embodiment performs contactless power feeding from the power feeding device 50 to the vehicle 1 by magnetic field resonant coupling (magnetic field resonance) when the vehicle 1 is traveling. In other words, the contactless power feeding system 100 transmits electric power from the power feeding device 50 to the vehicle 1 with a magnetic field as a medium. Contactless power feeding is also referred to as contactless power transmission, wireless power transmission, or wireless power feeding.

The power feeding device 50 is configured in such a way as to perform contactless power feeding to the vehicle 1. Specifically, as illustrated in FIG. 1, the power feeding device 50 includes an electric power source 51, a controller 52, a communication device 53, and a power transmission device 60. The power feeding device 50 according to the present embodiment is provided on a road (lane) where the vehicle 1 travels and for example, is embedded underground (under the road surface). At least part of the power feeding device 50 (such as the electric power source 51, the controller 52, and the communication device 53) may be placed above the road surface.

The electric power source 51 is an electric power source for the power transmission device 60 and supplies electric power to the power transmission device 60. For example, the electric power source 51 is a commercial alternating-current electric power source supplying single-phase alternating-current power. For example, the electric power source 51 may be an alternating-current electric power source supplying three-phase alternating-current power.

The power transmission device 60 is configured to generate an alternating magnetic field for transmitting electric power to the vehicle 1. The power transmission device 60 according to the present embodiment includes a power-transmission-side rectifier circuit 61, an inverter 62, and a power-transmission-side resonance circuit 63. Suitable alternating-current power (high-frequency power) is supplied to the power-transmission-side resonance circuit 63 through the power-transmission-side rectifier circuit 61 and the inverter 62 in the power transmission device 60.

The power-transmission-side rectifier circuit 61 is electrically connected to the electric power source 51 and the inverter 62. The power-transmission-side rectifier circuit 61 converts alternating-current power supplied from the electric power source 51 into direct-current power by rectification and supplies the direct-current power to the inverter 62. For example, the power-transmission-side rectifier circuit 61 is an AC-DC converter.

The inverter 62 is electrically connected to the power-transmission-side rectifier circuit 61 and the power-transmission-side resonance circuit 63. The inverter 62 converts direct-current power supplied from the power-transmission-side rectifier circuit 61 into alternating-current power (high-frequency power) with a frequency higher than that of alternating-current power of the electric power source 51 and supplies the high-frequency power to the power-transmission-side resonance circuit 63.

The power-transmission-side resonance circuit 63 includes a resonator configured with a power-transmitting coil 64 and a power-transmission-side capacitor 65. Various parameters of the power-transmitting coil 64 and the power-transmission-side capacitor 65 (such as the outside diameter and the inside diameter of the power-transmitting coil 64, the number of turns of the power-transmitting coil 64, and the capacitance of the power-transmission-side capacitor 65) are determined in such a way that the resonance frequency of the power-transmission-side resonance circuit 63 is equal to a predetermined set value. For example, the predetermined set value is in a range of 10 kHz to 100 GHz and is preferably 85 kHz determined as a frequency band for contactless power feeding of a vehicle by the SAE TIR J2954 standard.

The power-transmission-side resonance circuit 63 is placed in the middle of a lane on which the vehicle 1 travels in such a way that the center of the power-transmitting coil 64 is positioned in the middle of the lane. When high-frequency power supplied from the inverter 62 is applied to the power-transmission-side resonance circuit 63, the power-transmission-side resonance circuit 63 generates an alternating magnetic field for transmitting electric power to the vehicle 1. The electric power source 51 may be a direct-current electric power source such as a fuel cell or a solar cell, and the power-transmission-side rectifier circuit 61 may be omitted in this case. Further, a filter circuit suppressing high-frequency noise generated from the inverter 62 may be provided between the inverter 62 and the power-transmission-side resonance circuit 63.

For example, the controller 52 is a general-purpose computer and performs various types of control of the power feeding device 50. For example, the controller 52 is electrically connected to the inverter 62 in the power transmission device 60 and controls the inverter 62 in such a way as to control power transmission by the power transmission device 60.

The communication device 53 is equipment allowing communication between the power feeding device 50 and the outside of the power feeding device 50. For example, the communication device 53 includes a short-distance wireless communication module (for example, a dedicated short-range communication (DSRC) antenna or a Bluetooth (registered trademark) module) for performing short-distance wireless communication and a wide-area wireless communication module for performing wide-area wireless communication. The communication device 53 is electrically connected to the controller 52, and the controller 52 communicates with the vehicle 1 by using the communication device 53.

On the other hand, the vehicle 1 includes a power reception device 2 and is configured in such a way as to be fed with power in a contactless manner by the power feeding device 50. The power reception device 2 according to the present embodiment includes a power-reception side resonance circuit 21 and a power-reception side rectifier circuit 24.

The power-reception side resonance circuit 21 is placed at the bottom of the vehicle 1 in such a way as to minimize the distance to the road surface. The power-reception side resonance circuit 21 according to the present embodiment is placed in the middle of the vehicle 1 in the width direction of the vehicle and is placed between the front wheels and the rear wheels in the longitudinal direction of the vehicle 1.

The power-reception side resonance circuit 21 has a configuration similar to that of the power-transmission-side resonance circuit 63 and includes a resonator configured with a power-receiving coil 22 and a power-reception side capacitor 23. Various parameters of the power-receiving coil 22 and the power-reception side capacitor 23 (such as the outside diameter and the inside diameter of the power-receiving coil 22, the number of turns of the power-receiving coil 22, and the capacitance of the power-reception side capacitor 23) are determined in such a way that the resonance frequency of the power-reception side resonance circuit 21 matches the resonance frequency of the power-transmission-side resonance circuit 63. The resonance frequency of the power-reception side resonance circuit 21 does not necessarily match the resonance frequency of the power-transmission-side resonance circuit 63 as long as an amount of deviation between the resonance frequency of the power-reception side resonance circuit 21 and the resonance frequency of the power-transmission-side resonance circuit 63 is small, i.e., for example, the resonance frequency of the power-reception side resonance circuit 21 is within a ±20% range of the resonance frequency of the power-transmission-side resonance circuit 63.

As illustrated in FIG. 1, when an alternating magnetic field is radiated from the power-transmitting coil 64 while the power-receiving coil 22 in the power-reception side resonance circuit 21 is facing the power-transmitting coil 64 in the power-transmission-side resonance circuit 63, the oscillation of the alternating magnetic field is transmitted to the power-reception side resonance circuit 21 resonating at the same resonance frequency as that of the power-transmission-side resonance circuit 63. As a result, induced current flows through the power-receiving coil 22 in the power-reception side resonance circuit 21 by electromagnetic induction, and electric power is generated by the induced current. In other words, the power-receiving coil 22 receives electric power from the power-transmitting coil 64 provided on the road.

The power-reception side rectifier circuit 24 is electrically connected to the power-reception side resonance circuit 21. The power-reception side rectifier circuit 24 converts alternating-current power supplied from the power-reception side resonance circuit 21 into direct-current power by rectification. For example, the power-reception side rectifier circuit 24 is an AC-DC converter. A filter circuit eliminating alternating-current power noise may be provided between the power-reception side resonance circuit 21 and the power-reception side rectifier circuit 24.

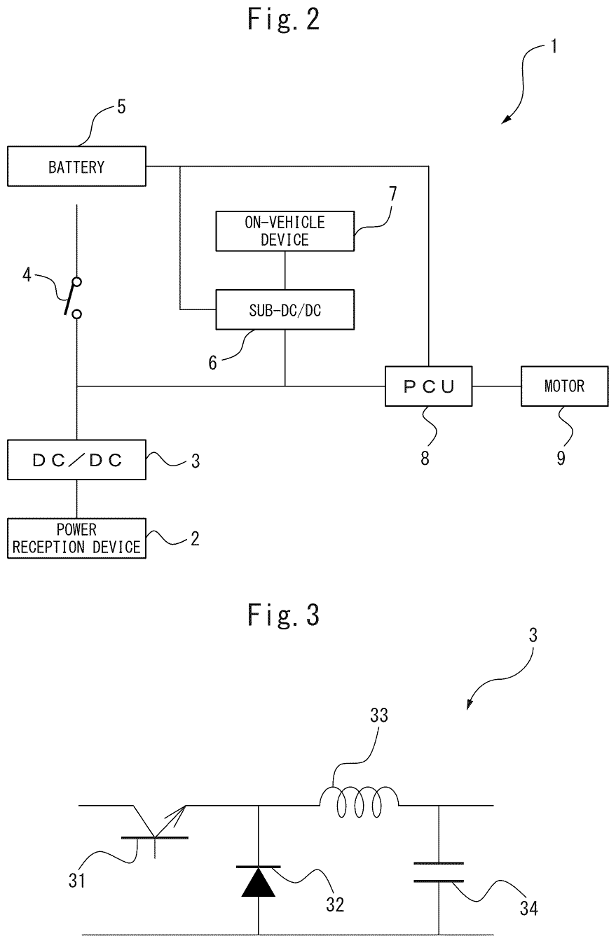

FIG. 2 is a diagram schematically illustrating a supply path of electric power in the vehicle 1. As illustrated in FIG. 2, the vehicle 1 includes a DC-DC converter 3, a relay 4, a battery 5, a sub-DC-DC converter 6, an on-vehicle device 7, a power control unit (PCU) 8, and a motor 9 in addition to the power reception device 2.

The DC-DC converter 3 is electrically connected to the power reception device 2 described above and specifically to the power-reception side rectifier circuit 24 in the power reception device 2. FIG. 3 is a diagram illustrating an example of a configuration of the DC-DC converter 3. As illustrated in FIG. 3, the DC-DC converter 3 includes a switching element 31, a diode 32, a choke coil 33, and a capacitor 34.

By using the switching element 31, the DC-DC converter 3 converts the voltage value of direct-current power output from the power reception device 2. Specifically, the DC-DC converter 3 switches the switching element 31 between an on-state and an off-state and outputs voltage with a desired value by controlling a time ratio of the on-state to the off-state (a duty ratio). FIG. 3 illustrates a step-down DC-DC converter (a buck converter), and in this case, the DC-DC converter 3 steps down the voltage of input electric power. The DC-DC converter 3 may be a step-up DC-DC converter (a boost converter) or a step-up/down DC-DC converter (a buck-boost converter).

The relay 4 is placed between the DC-DC converter 3 and the battery 5 and controls an electric connection between the DC-DC converter 3 and the battery 5. When the relay 4 is connected, i.e., when the relay 4 is in a closed state, electric power is supplied from the power reception device 2 to the battery 5 through the DC-DC converter 3. On the other hand, when the relay 4 is broken, i.e., when the relay 4 is in an open state, power supply from the power reception device 2 to the battery 5 is broken.

The battery 5 accumulates electric power consumed in the vehicle 1. The battery 5 is a rechargeable secondary battery such as a lithium-ion battery or a nickel-hydrogen battery. When electric power is supplied from the power reception device 2 to the battery 5, the battery 5 is charged, and a state of charge (SOC) of the battery 5 is restored. Further, the battery 5 may be charged by an external electric power source other than the power feeding device 50 through a charge port provided in the vehicle 1.

The sub-DC-DC converter 6 is electrically connected to the DC-DC converter 3 and the battery 5 and is supplied with electric power from at least one of the power reception device 2 and the battery 5. The sub-DC-DC converter 6 steps down input voltage input to the sub-DC-DC converter 6 and supplies the stepped-down voltage to the on-vehicle device 7.

The on-vehicle device 7 is a part consuming electric power in the vehicle 1, examples of the device including an air conditioner, auxiliary machinery (such as an alternator, a water pump, and an oil pump), lighting equipment, and audio equipment.

The PCU 8 is electrically connected to the DC-DC converter 3 and the battery 5 and is supplied with electric power from at least one of the power reception device 2 and the battery 5. The PCU 8 includes an inverter and a step-up converter. The inverter converts direct-current power input to the PCU 8 into alternating-current power and supplies the alternating-current power to the motor 9. Further, the inverter converts alternating-current power generated by the motor 9 (regenerative electric power) into direct-current power and supplies the direct-current power to the battery 5. The step-up converter steps up direct-current voltage when regenerative electric power is supplied to the battery 5. The sub-DC-DC converter 6 and the PCU 8 may be integrally configured.

The motor 9 is an electric motor (such as an alternating-current synchronous motor) and is driven with electric power as a power source. The output of the motor 9 is transmitted to the wheels through a speed reducer and an axle. The vehicle 1 according to the present embodiment is a battery electric vehicle (BEV) not equipped with an internal combustion engine, and the motor 9 outputs power for traveling.

As illustrated in FIG. 2, the vehicle 1 according to the present embodiment includes the on-vehicle device 7 and the motor 9 as an electric load. Electric power received by the power reception device 2 is supplied to at least one of the battery 5 and the electric load through the DC-DC converter 3 depending on, for example, an open-close state of the relay 4.

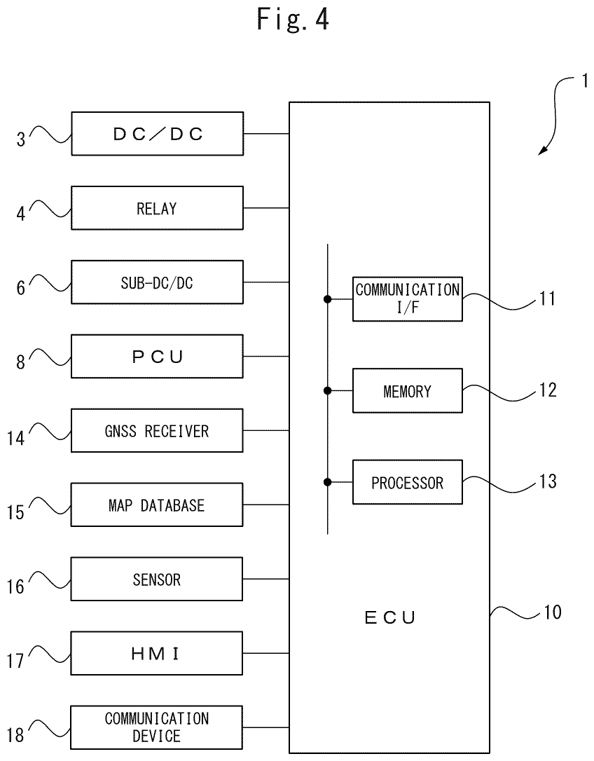

FIG. 4 is a schematic configuration diagram of an electronic control unit (ECU) 10 in the vehicle 1 and equipment connected to the ECU 10. The vehicle 1 includes the ECU 10 as a control device of the vehicle 1. The ECU 10 executes various types of control of the vehicle 1.

As illustrated in FIG. 4, the ECU 10 includes a communication interface 11, a memory 12, and a processor 13. The communication interface 11, the memory 12, and the processor 13 are connected to each other through a signal line.

The communication interface 11 includes an interface circuit for connecting the ECU 10 to an on-vehicle network conforming to a standard such as a controller area network (CAN).

For example, the memory 12 includes a volatile semiconductor memory (such as a RAM) and a nonvolatile semiconductor memory (such as a ROM). The memory 12 stores a program executed by the processor 13, various types of data used when various types of processing are executed by the processor 13, or the like.

The processor 13 includes one or a plurality of central processing units (CPUs) and a peripheral circuit thereof and executes various types of processing. The processor 13 may further include an arithmetic circuit such as a logical operation unit or a numeric operation unit.

As illustrated in FIG. 4, the DC-DC converter 3, the relay 4, the sub-DC-DC converter 6, and the PCU 8 that are described above are electrically connected to the ECU 10. The ECU 10 controls power supply in the vehicle 1 by controlling each of the DC-DC converter 3, the relay 4, the sub-DC-DC converter 6, and the PCU 8.

The vehicle 1 further includes a global navigation satellite system (GNSS) receiver 14, a map database 15, a sensor 16, a human machine interface (HMI) 17, and a communication device 18, which are electrically connected to the ECU 10.

The GNSS receiver 14 detects the current position of the vehicle 1 (such as the latitude and longitude of the vehicle 1), based on positioning information acquired from a plurality of (for example, three or more) positioning satellites. Specifically, the GNSS receiver 14 captures a plurality of positioning satellites and receives radio waves transmitted from the positioning satellites. Then, the GNSS receiver 14 calculates the distance to a positioning satellite, based on the difference between the time of transmission and the time of reception of radio waves and detects the current position of the vehicle 1, based on the distances to the positioning satellites and the positions (orbit information) of the positioning satellites. The output of the GNSS receiver 14, i.e., the current position of the vehicle 1 detected by the GNSS receiver 14 is transmitted to the ECU 10.

The map database 15 stores map information. The map information includes positional information of a power feeding area to be described later, or the like. The ECU 10 acquires the map information from the map database 15. The map database may be provided outside the vehicle 1 (for example, in a server), and the ECU 10 may acquire the map information from outside the vehicle 1.

The sensor 16 detects a state of the vehicle 1 or an area around the vehicle 1. The sensor 16 according to the present embodiment includes a vehicle speed sensor detecting the speed of the vehicle 1, an outdoor temperature sensor detecting the outdoor temperature, a battery temperature sensor detecting the temperature of the battery 5, the battery current sensor detecting input-output current of the battery 5, or the like. The output of the sensor 16, i.e., the state of the vehicle 1 or the area around the vehicle 1 detected by the sensor 16 is transmitted to the ECU 10.

The HMI 17 performs input and output of information between the vehicle 1 and a crew of the vehicle 1 (such as a driver). For example, the HMI 17 includes a display displaying information, a speaker generating a sound, an operation button, an operation switch, or a touch screen for the crew to perform an input operation, and a microphone receiving a voice of the crew. The output of the ECU 10 is transmitted to the crew through the HMI 17, and input from the crew is transmitted to the ECU 10 through the HMI 17. The HMI 17 is an example of an input device, an output device, or an input-output device.

The communication device 18 is equipment allowing communication between the vehicle 1 and the outside of the vehicle 1. For example, the communication device 18 includes a short-distance wireless communication module (for example, on-vehicle dedicated short range communication (DSRC) equipment or a Bluetooth (registered trademark) module) for performing short-distance wireless communication and a wide-area wireless communication module (for example, a data communication module (DCM)) for performing wide-area wireless communication. The ECU 10 communicates with the power feeding device 50 by using the communication device 18.

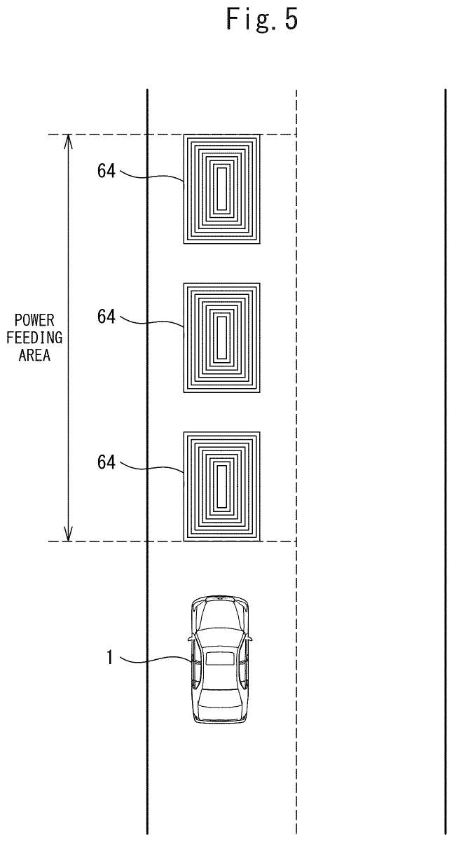

FIG. 5 is a diagram illustrating an example of a power feeding area where the power-transmitting coil 64 in the power feeding device 50 is installed. Three power-transmitting coils 64 are spaced on the same lane of a road along the traveling direction of the vehicle 1 in the example in FIG. 5. An area on a lane where a plurality of power-transmitting coils 64 are continuously installed corresponds to the power feeding area.

For example, when the vehicle 1 approaches the power feeding area, the ECU 10 transmits a power feeding request signal for requesting power feeding to the vehicle 1 to the power feeding device 50 by using the communication device 18. When receiving the power feeding request signal from the vehicle 1, the controller 52 in the power feeding device 50 generates an alternating magnetic field for power transmission by the power transmission device 60. In other words, when receiving the power feeding request signal from the vehicle 1, the controller 52 starts contactless power feeding from the power feeding device 50 to the vehicle 1.

When electric power is transmitted from the power-transmitting coil 64 in the power transmission device 60 to the power-receiving coil 22 in the power reception device 2, an electric energy is adjusted by a switching operation of the DC-DC converter 3 provided in the vehicle 1. Thus, power can be stably supplied from the power feeding device 50 to the vehicle 1, and by extension, a required amount of power feeding to the vehicle 1 can be secured. However, when voltage conversion by the switching operation is performed every time electric power is supplied through the DC-DC converter 3, a power loss due to the switching operation occurs in the vehicle 1.

Then, based on a predetermined condition, the ECU 10 according to the present embodiment switches the state of the DC-DC converter 3 when electric power is supplied from the power reception device 2 to at least one of the battery 5 and the electric load through the DC-DC converter 3 between a non-operating state and an operating state. In the non-operating state of the DC-DC converter 3, the switching element 31 in the DC-DC converter 3 is maintained in an on-state, and conversion of a voltage value by the DC-DC converter 3 is not performed. On the other hand, in the operating state of the DC-DC converter 3, the switching element 31 in the DC-DC converter 3 is switched between the on-state and an off-state, and conversion of a voltage value (step-down or step-up) by the DC-DC converter 3 is performed.

Since the switching operation of the DC-DC converter 3 is suspended in the non-operating state of the DC-DC converter 3, a power loss due to the switching operation does not occur. On the other hand, electric power can be stably supplied from the power-transmitting coil 64 in the power feeding device 50 to the power-receiving coil 22 in the vehicle 1 by adjusting an electric energy by the switching operation of the DC-DC converter 3 in the operating state of the DC-DC converter 3. Accordingly, switching the state of the DC-DC converter 3 between the non-operating state and the operating state, based on the predetermined condition, enables suppression of a power loss in the vehicle 1 while securing required electric power by power feeding.

For example, the predetermined condition includes a received power reduction condition. The received power reduction condition is a condition for allowing reduction in an electric energy received by the power-receiving coil 22 in the vehicle 1 and is satisfied when reduction in an electric energy is allowed. The ECU 10 sets the state of the DC-DC converter 3 to the non-operating state when the received power reduction condition is satisfied and sets the state of the DC-DC converter 3 to the operating state when the received power reduction condition is not satisfied. Setting the state of the DC-DC converter 3, based on the received power reduction condition, can suppress shortage of electric power in the vehicle 1 due to reduction in received electric power in the non-operating state of the DC-DC converter 3.

Further, the predetermined condition includes a power fluctuation inhibition condition. The power fluctuation inhibition condition is a condition for inhibiting fluctuation in an electric energy supplied from the DC-DC converter 3 to the battery 5 and is satisfied when fluctuation in an electric energy is inhibited. In this case, the ECU 10 sets the state of the DC-DC converter 3 to the operating state when the power fluctuation inhibition condition is satisfied while electric power is supplied from the power reception device 2 to the battery 5 through the DC-DC converter 3. In other words, even when the received power reduction condition is satisfied, the ECU 10 sets the state of the DC-DC converter 3 to the operating state when the power fluctuation inhibition condition is satisfied. Setting the state of the DC-DC converter 3, based on the power fluctuation inhibition condition, can suppress, for example, degradation of the battery 5 due to electric power fluctuation.

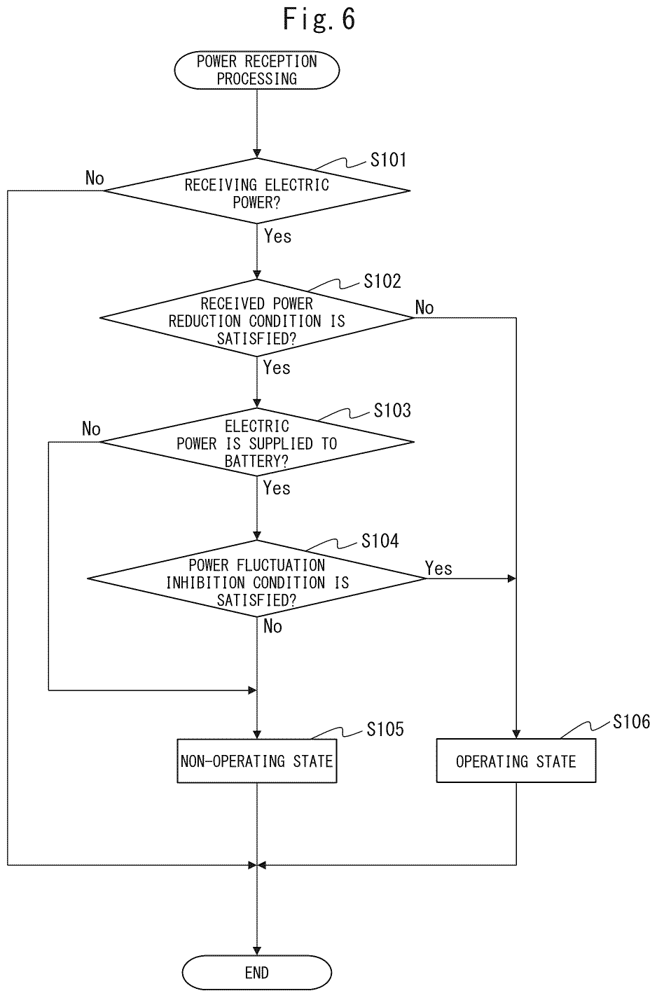

A flow of the control described above will be described below with reference to a flowchart in FIG. 6. FIG. 6 is a flowchart illustrating a control routine of power reception processing. The control routine is repeatedly executed by the ECU 10 at predetermined execution intervals.

First, in step S101, the ECU 10 determines whether the power reception device 2 is receiving electric power. For example, the determination is made based on positional information of the vehicle 1 and the power feeding area, power feeding information transmitted from the power feeding device 50 to the vehicle 1, and/or the output of a current sensor or a voltage sensor provided in the power reception device 2. When the power reception device 2 is determined to be not receiving electric power, the control routine ends. On the other hand, when the power reception device 2 is determined to be receiving electric power, the control routine advances to step S102.

In step S102, the ECU 10 determines whether a predetermined received power reduction condition is satisfied. When the length of the power feeding area is long, time to feed electric power to the vehicle 1 can be secured; and therefore, reduction in an electric energy supplied to the vehicle 1 per unit time is allowed. Therefore, for example, the received power reduction condition is that the length of the power feeding area on which the vehicle 1 travels has a value equal to or greater than a predetermined value. In this case, the received power reduction condition is satisfied when the length of the power feeding area on which the vehicle 1 travels has a value equal to or greater than the predetermined value and is not satisfied when the length of the power feeding area on which the vehicle 1 travels has a value less than the predetermined value. For example, the predetermined value is set in a range of 10 m to 200 m. For example, positional information of the power feeding area including the length of the power feeding area is stored in the map information in the map database 15.

Further, when the SOC of the battery 5 does not run short, necessity to increase an amount of power feeding to the vehicle 1 is not so great. Therefore, the received power reduction condition may be that the SOC of the battery 5 has a value equal to or greater than a predetermined value. In this case, the received power reduction condition is satisfied when the SOC of the battery 5 has a value equal to or greater than the predetermined value and is not satisfied when the SOC of the battery 5 has a value less than the predetermined value. For example, the predetermined value is set in a range of 50% to 80% and is preferably set to 65%. For example, the SOC of the battery 5 is calculated by integrating input-output current of the battery 5 detected by the battery current sensor or is calculated by using a state estimation method such as a Kalman filter.

Further, the received power reduction condition may be a condition related to an electric energy consumed in the vehicle 1. In this case, for example, the received power reduction condition includes that the power consumption of the motor 9 has a value equal to or less than a predetermined value. In other words, the received power reduction condition is satisfied when the power consumption of the motor 9 has a value equal to or less than the predetermined value and is not satisfied when the power consumption of the motor 9 has a value greater than the predetermined value. For example, the predetermined value is set in a range of 2 kW to 4 kW and is preferably set to 3 kW. For example, the power consumption of the motor 9 is calculated based on required torque and/or electric power supplied to the motor 9.

Basically, an electric energy consumed in the vehicle 1 increases as the speed of the vehicle 1 increases. Therefore, the received power reduction condition may include that the speed of the vehicle 1 has a value equal to or less than a predetermined value as a condition related to an electric energy consumed in the vehicle 1. In this case, the received power reduction condition is satisfied when the speed of the vehicle 1 has a value equal to or less than the predetermined value and is not satisfied when the speed of the vehicle 1 has a value greater than the predetermined value. For example, the predetermined value is set in a range of 15 km/h to 40 km/h and is preferably set to 20 km/h. For example, the speed of the vehicle 1 is calculated based on the output of the vehicle speed sensor.

Further, the received power reduction condition may include that the power consumption of the air conditioner has a value equal to or less than a predetermined value as a condition related to an electric energy consumed in the vehicle 1. In this case, the received power reduction condition is satisfied when the power consumption of the air conditioner has a value equal to or less than the predetermined value and is not satisfied when the power consumption of the air conditioner has a value greater than the predetermined value. For example, the predetermined value is set in a range of 0.3 kW to 1 kW and is preferably set to 0.5 kW. For example, the power consumption of the air conditioner is calculated based on setting information of the air conditioner (such as a set temperature and an airflow volume) input to the HMI 17 by a crew of the vehicle 1 and/or electric power supplied to the air conditioner.

Further, when the outdoor temperature is a comfortable temperature for a crew of the vehicle 1, the air conditioner is not likely to be operated. Therefore, the received power reduction condition may include that the outdoor temperature is within a predetermined range as a condition related to an electric energy consumed in the vehicle 1. In this case, the received power reduction condition is satisfied when the outdoor temperature is within the predetermined range and is not satisfied when the outdoor temperature is out of the predetermined range. For example, the predetermined range is set to 5° C. to 20° C. or 10° C. to 20° C. For example, the outdoor temperature is calculated based on the output of the outdoor temperature sensor or is acquired based on weather information transmitted to the vehicle 1 from outside the vehicle 1.

All or part of the conditions described above may be used as a condition related to an electric energy consumed in the vehicle 1. When a condition related to an electric energy consumed in the vehicle 1 includes a plurality of conditions, the received power reduction condition is satisfied when all of the plurality of conditions are satisfied, and the received power reduction condition is not satisfied when at least one condition out of the plurality of conditions is not satisfied.

When the received power reduction condition is determined to be satisfied in step S102, the control routine advances to step S103. In step S103, the ECU 10 determines whether electric power is supplied from the power reception device 2 to the battery 5 through the DC-DC converter 3. For example, the determination is made based on the state of the relay 4 and/or the output of the battery current sensor. When electric power is determined to be supplied to the battery 5 in step S103, the control routine advances to step S104.

In step S104, the ECU 10 determines whether the power fluctuation inhibition condition is satisfied. When the temperature of the battery 5 is off a proper temperature, degradation of the battery 5 may be accelerated due to fluctuation in electric power supplied to the battery 5. Therefore, for example, the power fluctuation inhibition condition includes that the temperature of the battery 5 is out of a predetermined range. In this case, the power fluctuation inhibition condition is satisfied when the temperature of the battery 5 is out of the predetermined range and is not satisfied when the temperature of the battery 5 is within the predetermined range. For example, the predetermined range is set to 0° C. to 45° C. For example, the temperature of the battery 5 is calculated based on the output of the battery temperature sensor.

Further, the power fluctuation inhibition condition may include that each of electric power that can be charged to the battery 5 and electric power that can be discharged from the battery 5 has a value equal to or less than a predetermined value. In this case, the power fluctuation inhibition condition is satisfied when each of electric power that can be charged to the battery 5 and electric power that can be discharged from the battery 5 has a value equal to or less than the predetermined value and is not satisfied when at least either of electric power that can be charged to the battery 5 and electric power that can be discharged from the battery 5 has a value greater than the predetermined value. For example, the predetermined value is set in a range of 2 kW to 4 kW and is preferably set to 3 kW. Electric power that can be charged to the battery 5 is calculated as the absolute value of allowable charged power Win and for example, is calculated based on the SOC of the battery 5 and/or the temperature of the battery 5. Electric power that can be discharged from the battery 5 is calculated as allowable discharged power Wout and for example, is calculated based on the SOC of the battery 5 and/or the temperature of the battery 5.

When the power fluctuation inhibition condition is determined to be not satisfied in step S104, the control routine advances to step S105. When electric power is determined to be not supplied to the battery 5 in step S103, the control routine skips step S104 and advances to step S105. In step S105, the ECU 10 sets the state of the DC-DC converter 3 to the non-operating state. In other words, the ECU 10 maintains the switching element 31 in the DC-DC converter 3 in the on-state. The control routine ends after step S105.

On the other hand, when the received power reduction condition is determined to be not satisfied in step S102 or the power fluctuation inhibition condition is determined to be satisfied in step S104, the control routine advances to step S106. In step S106, the ECU 10 sets the state of the DC-DC converter 3 to the operating state. In other words, the ECU 10 switches the switching element 31 in the DC-DC converter 3 between the on-state and the off-state according to a set value of the duty ratio. The control routine ends after step S106.

While a preferred embodiment according to the present invention has been described above, the present invention is not limited to the embodiment, and various modifications and changes can be made within the scope of the claims. For example, the vehicle 1 may be a hybrid electric vehicle (HEV) or a plug-in hybrid electric vehicle (PHEV) including an internal combustion engine and a motor as power sources for traveling.

Further, steps S103 and S104 may be omitted in the control routine of the power reception processing in FIG. 6.

### REFERENCE SIGNS LIST

1 Vehicle
2 Power reception device
22 Power-receiving coil
3 DC-DC converter
31 Switching element
5 Battery
7 On-vehicle device
9 Motor
10 Electronic control unit (ECU)
50 Power feeding device
60 Power transmission device
64 Power-transmitting coil

1. A vehicle comprising:
a battery;
an electric load;
a power reception device including a power-receiving coil receiving electric power from a power-transmitting coil provided on a road;
a DC-DC converter converting, by using a switching element, a voltage value of direct-current power output from the power reception device; and
a control device controlling the DC-DC converter, wherein,
based on a predetermined condition, the control device switches a state of the DC-DC converter when electric power is supplied from the power reception device to at least one of the battery and the electric load through the DC-DC converter between a non-operating state in which the switching element is maintained in an on-state and an operating state in which the switching element is switched between an on-state and an off-state.

2. The vehicle according to claim 1, wherein
the control device sets a state of the DC-DC converter to the non-operating state when a predetermined received power reduction condition is satisfied.

3. The vehicle according to claim 2, wherein
the received power reduction condition is that a length of a power feeding area in which the vehicle travels has a value equal to or greater than a predetermined value.

4. The vehicle according to claim 2, wherein
the received power reduction condition is that an SOC of the battery has a value equal to or greater than a predetermined value.

5. The vehicle according to claim 2, wherein
the received power reduction condition is a condition related to an electric energy consumed in the vehicle.

6. The vehicle according to claim 5, wherein
the electric load includes a motor, and
the received power reduction condition includes that power consumption of the motor has a value equal to or less than a predetermined value.

7. The vehicle according to claim 5, wherein
the received power reduction condition includes that speed of the vehicle has a value equal to or less than a predetermined value.

8. The vehicle according to claim 5, wherein
the electric load includes an air conditioner, and
the received power reduction condition includes that power consumption of the air conditioner has a value equal to or less than a predetermined value.

9. The vehicle according to claim 5, wherein
the electric load includes an air conditioner, and
the received power reduction condition includes that outdoor temperature is within a predetermined range.

10. The vehicle according to claim 1, wherein
the control device sets a state of the DC-DC converter to the operating state when a predetermined power fluctuation inhibition condition is satisfied while electric power is supplied from the power reception device to the battery through the DC-DC converter.

11. The vehicle according to claim 10, wherein
the power fluctuation inhibition condition includes that temperature of the battery is out of a predetermined range.

12. The vehicle according to claim 10, wherein
the power fluctuation inhibition condition includes that each of electric power that can be charged to the battery and electric power that can be discharged from the battery has a value equal to or less than a predetermined value.

13. A vehicle control device that controls a vehicle including: a battery; an electric load; a power reception device including a power-receiving coil receiving electric power from a power-transmitting coil provided on a road; and a DC-DC converter converting, by using a switching element, a voltage value of direct-current power output from the power reception device, wherein,
the vehicle is configured, based on a predetermined condition, to switch a state of the DC-DC converter when electric power is supplied from the power reception device to at least one of the battery and the electric load through the DC-DC converter, between a non-operating state in which the switching element is maintained in an on-state and an operating state in which the switching element is switched between an on-state and an off-state.

14. A vehicle control method for controlling a vehicle including: a battery; an electric load; a power reception device including a power-receiving coil receiving electric power from a power-transmitting coil provided on a road; and a DC-DC converter converting, by using a switching element, a voltage value of direct-current power output from the power reception device, the method comprising,
based on a predetermined condition, switching a state of the DC-DC converter when electric power is supplied from the power reception device to at least one of the battery and the electric load through the DC-DC converter between a non-operating state in which the switching element is maintained in an on-state and an operating state in which the switching element is switched between an on-state and an off-state.
